(19) United States
(12) Patent Application Publication
(10) Pub. No.: US 2015/0184937 A1
(43) Pub. Date: Jul. 2, 2015

(54) PORTABLE CONTAINER WITH FAN

(71) Applicant: Steven Hywel, Bedminster, NJ (US)

(72) Inventor: Steven Hywel, Bedminster, NJ (US)

(21) Appl. No.: 14/567,102

(22) Filed: Dec. 11, 2014

Related U.S. Application Data
(60) Provisional application No. 61/922,894, filed on Jan. 2, 2014.

(51) Int. Cl. F26B 9/00; F26B 9/06

(52) U.S. Cl. CPC F26B 9/003; F26B 9/066

(57) ABSTRACT

A portable container for holding items, particularly baby wipes and other changing essentials, is described and taught. The portable container may have an adjustable strap for carrying, and is capable of being secured to prevent the drying of wet, or moist, baby wipes. The portable container has an integrated fan for blowing air to dry an infant during the changing process. The fan may be stationary, articulating, repositionable, or any combination thereof. The fan may have a telescoping, hingeable arm with a spring clip for maneuvering and positioning the fan. Additionally, the portable container may provide for directional air flow mechanisms such as directionally adjustable air vents, or slits. The portable container further has a number of LEDs for illuminating the changing and surrounding area, and also may have an inlet port for supplying a fragrance to the blown air.

### CLAIM OF PRIORITY

This application claims priority to US Application Ser. No. 61/922,894 filed on Jan. 2, 2014, the contents of which are herein fully incorporated by reference in its entirety.

### FIELD OF THE INVENTION

The field of the invention relates to portable containers with multiple functionalities, namely a portable container with an air blowing device. In particular, to a portable baby wipe container that has an integrated fan for drying an infant while changing thereby promoting health and hygiene.

### BACKGROUND OF THE INVENTION

In the early stages of life, children are incapable of taking care of themselves. They need to be fed, bathed, clothed, and changed on a regular basis. For the first couple years or so, it is common for children to wear diapers at all times. These diapers need to be periodically changed when they become soiled. The soiled diaper is removed and the child is cleaned, typically with pre-moistened wipes, and a new diaper is put on the child.

One side effect of wearing diapers is that the diapers can promote skin irritation of the child, especially those 9-12 months in age. This skin irritation is commonly referred to as “diaper rash.” Diaper rash has a variety of causes including friction, fungal infections, and allergic reactions. The rash can be painful for the child and cause a good deal of general discomfort. In order to help prevent diaper rash it is advised by medical professionals to regularly change soiled diapers and properly clean and dry a child before placing them in a new diaper. However, this can often be a time consuming process, especially when the parent and child are not at home.

Allowing the child to “air dry” is not an option in this scenario and other more expedient methods do a less than adequate job. Additionally, getting a child to remain still for any duration of time in order to adequately dry them with a towel is near impossible. Allowing a child to “air dry” can also bring upon the increased chance of a child going to the bathroom without wearing a diaper. Thus, it is desirable to have an apparatus that fully and expeditiously dries an infant after a diaper change and before placing them in a new diaper. It is also desirable to have such an apparatus be readily portable and be capable of containing any and all supplies required by the parent to quickly and properly change their child. Review of related technology:

U.S. Pat. No. 6,928,285 pertains to a forced air dryer designed to dry an infant's bottom during the diaper changing process comprising a housing having an end piece designed to reduce skin abrasion, skin heating, and air flow blockage. In one embodiment, the device is powered by a rechargeable electric battery. In another embodiment, the invention is associated with a diaper changing table.

U.S. Pat. No. 6,667,464 pertains to a multi-functional cabinet for warming and adding fragrance to an infant's towel and clothing for a predetermined duration as well as providing soothing music. The cabinet is a box-shaped enclosure with a removable lid having an upper compartment for receiving towels and clothing with a sidewall pocket for receiving a fragrance such as baby powder or baby lotion, and a pair of lower compartments for housing a heating element/blower fan and a music source, such as a music box, a compact disc player or tape player. A timer is connected to the heating element, and may also be connected to the music source.

U.S. Pat. No. 6,401,727 pertains to an apparatus having multiple plastic trays covered with pivotable lids. Each tray is divided into distinct compartments into which infant and toddler toothbrushes, teething rings, pacifiers, or other such personal hygiene products may be placed. The lid is punctured by an array of air holes, which allow moisture to escape from the covered tray, while at the same time protecting the tray contents from contamination. The covered trays are received within an open front rack in a vertically spaced arrangement. Air cavities defined between stacked trays permit natural air flow over the trays, and the removal of moisture from the tray contents. A fan may be attached to the rear of the rack to blow air over the lids and to draw the moist air from within the compartments through the lid air holes.

U.S. Pat. No. 5,394,620 pertains to a hand held, portable body dryer for the entire body including a hollow tube carrying a hollow hand grip in which a battery is disposed;

a fan and a heater are disposed in the tube with rheostatic controls therefore on the exterior of the tube with indications for off, low and high positions, and with a reverse fan switch for cleaning the tube. A plurality of attachments for the dryer function as outlet nozzles for assuring entire body coverage.

Various devices are known in the art. However, their structure and means of operation are substantially different from the present disclosure. Some of the other apparatuses for drying include and use heating elements which should be avoided with infants. Additionally, other known devices lack a readily portable storage container having a dual function as a personal dryer. As such, the other inventions fail to solve all the problems taught by the present disclosure. At least one embodiment of this invention is presented in the drawings below and will be described in more detail herein.

### SUMMARY OF THE INVENTION

A portable container is described and taught having a housing with a top, a bottom, a pair of first walls, and a pair of second walls, wherein the top has an opening forming a cavity and one of the second walls has a plurality of openings; a hinged lid attached to the top, wherein the lid can pivot from an open to a closed position thereby uncovering and covering the cavity; a dividing wall that compartmentalizes the cavity into a storage area and a component area; a fan situated in the component area and positioned to blow air outwards from the component area through the plurality of openings in the second wall; a plurality of light emitting diodes positioned along an outside edge of the container; and a power source for powering the fan.

The portable container further has at least two slidable/depressible buttons. These buttons are used for changing the operative state of the plurality of light emitting diodes (LEDs) as well as changing the operative state of the fan. The portable container is designed to be a container for carrying baby wipes and as such may also should include an adjustable (length) carrying strap. The strap should be secured to the housing in a way that does not interfere with the functionality of the container as a whole. Additionally, the container and seal formed with the lid should be substantially impermeable in order to prevent drying of the baby wipes contained therein. This may be achieved using a rubberized or similar type seal affixed to either surface or complimentary surfaces that interlock with one another.

The portable container contains a fan used for blowing gases (air) to aid in drying of an infant having their diaper changed. The cavity of the container is divided into two sections: a storage area and a component area. The storage area is used for the storing of baby wipes or other changing materials. The component area is used for the storing of the fan. The fan is preferably battery powered and may be powered by dry cell or rechargeable batteries.

Additionally, the inclusion of solar cells may provide an alternate power source. The fan can be used in a number of operative positions. For example, the fan can be used from its position in the component area and used to blow air through the plurality of openings in the sidewall of the container. In this instance, the air flow may be directable by the inclusion of adjustable slits formed as part of the sidewall. These slits may be vertically, horizontally, or rotatably adjustable. The fan may also provide for such and other similar air direction mechanisms. Additionally, the inclusion of an inlet port that leads to the component area provides for the addition of fragrances and/or powders if so desired by the user.

The fan may also be used in different configurations. The fan may be removable and have a telescoping, hingeable arm. The arm further has a spring clip attached. This permits the fan to be removed from the component area and clipped to a part of the portable container. The arm provides flexibility for the user in orienting the fan to achieve the maximum or otherwise desired air flow. The fan may also lack an attached arm and the spring clip is used to attach the fan housing directly to an edge on the portable container.

In another embodiment, there is a portable container having a housing with an outside surface and an inside surface with a top, a bottom, a pair of first walls, and a pair of second walls, wherein the top has an opening forming a cavity and at least one of the second walls has a plurality of openings on the outside surface of the wall forming an air intake; a hinged lid attached to the top, wherein the lid can pivot from an open to a closed position thereby uncovering and covering the cavity; a fan situated between the inside and outside surface of one of the second walls; a plurality of light emitting diodes, wherein the operative state of the light emitting diodes is controlled by a depressible button; and a power source for powering the fan.

Here, the portable container makes use of a centrifugal fan. The fan is located in the sidewall of the portable container. The centrifugal fan has an air intake and an exhaust area. The impellers may be forward curved, backwards curved, or radial in shape. The portable container also has an air intake area and an exhaust area. The air intake area is covered with a mesh, or similar barrier, for safety purposes. The openings in the barrier (mesh) should be of the size to prevent any contact with the fan or its components. When the fan is turned on, using a depressible button, air is drawn in through the air intake and accelerated by the fan leaving the portable container through the exhaust port. The locations of the air intake and exhaust ports may vary. In order to service the fan or replace the batteries, a slidable cover is present thereby giving a user access to the fan containing area.

In general, the present invention succeeds in conferring the following, and others not mentioned, benefits and objectives.

It is an object of the present invention to provide a portable container that can be used to carry baby wipes and other infant care items.

It is an object of the present invention to provide a portable container that is durable and relatively inexpensive.

It is an object of the present invention to provide a portable container that can provide the diaper changing process with a pleasant scent.

It is another object of the present invention to provide a portable container that uses blown air to dry an infant during the changing process.

It is another object of the present invention to provide a portable container with an articulating fan to provide air flow independent the position of the portable container.

It is an object of the present invention to provide a portable container that can illuminate a changing area.

It is an object of the present invention to provide a portable container that securely stores wet (pre-moistened) baby wipes and prevents them from drying out in between use.

It is still another object of the present invention to provide a portable container that has adjustable air flow mechanisms that control the direction and/or speed of the airflow.

### BRIEF DESCRIPTION OF THE DRAWINGS

FIG. 1A is a perspective view of the present invention showing the flow of air generated by the invention.

FIG. 1B is a perspective view of the present invention with the flow of air reversed.

FIG. 2 is a top view of the present invention.

FIG. 3 is a bottom view of the present invention.

FIG. 4 is a perspective side view of the present invention showing the various components of the invention.

FIG. 5A is an example of a type of fan used in the present invention.

FIG. 5B is a side view of the present invention showing the location of the fan within the sidewall of the invention.

FIG. 6 is an alternate embodiment of the present invention using a removable, articulating fan.

### DETAILED DESCRIPTION OF THE DRAWINGS

The preferred embodiments of the present invention will now be described with reference to the drawings. Identical elements in the various figures are identified, as far as possible, with the same reference numerals. Reference will now be made in detail to embodiments of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto without deviating from the innovative concepts of the invention.

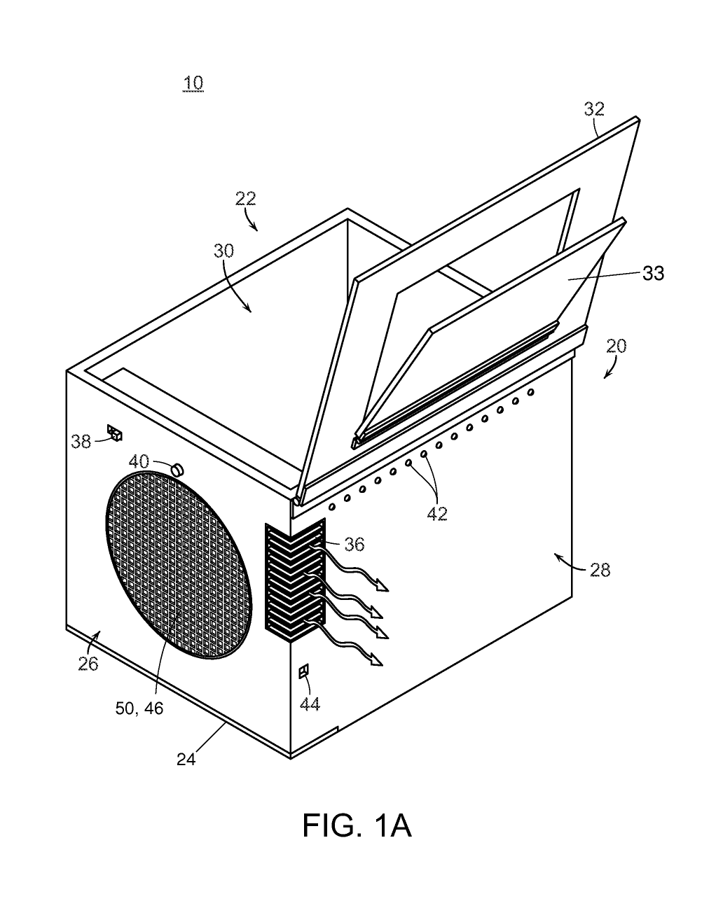

Referring to FIGS. 1A and 1B, there is a portable container 10 having a top 22, bottom 24, a pair of first walls 26, and a pair of second walls 28. The top 22 has an opening forming a cavity 30. There is a lid 32, which is attached to one lateral edge of the container 10, is hingeable and can cover or uncover the cavity 30. The lid 32 may also be removable. The lid 32 may further have a secondary opening 33 that may be used in lieu of the lid 32.

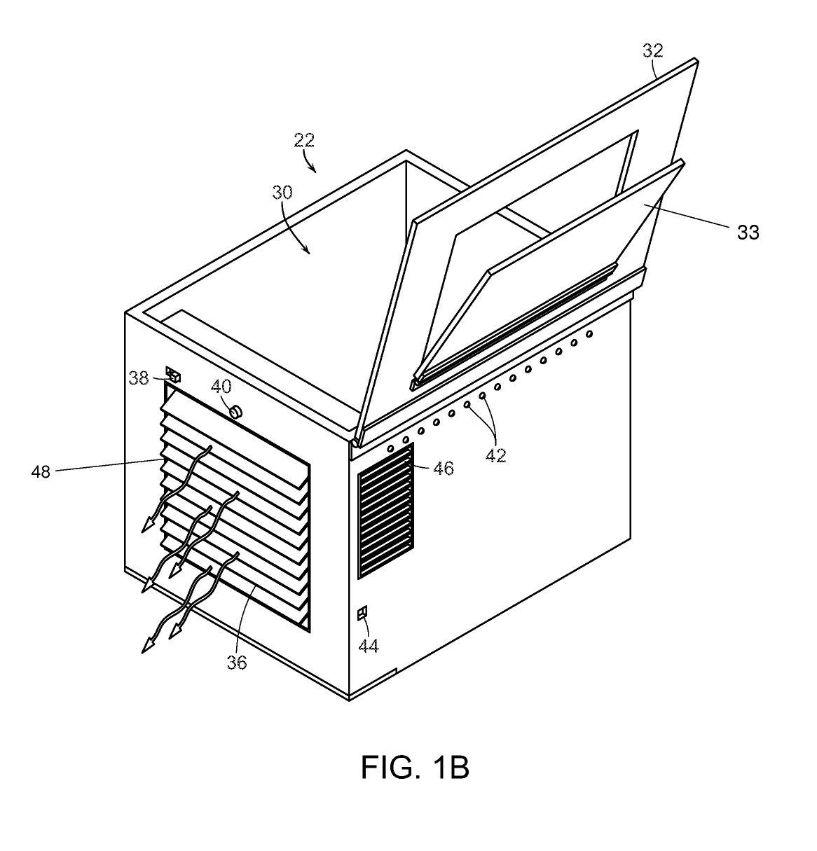

There is a fan contained within one of the walls (see FIG. 2). The walls also provide an air intake 46 and an exhaust 36. The location of the air intake 46 and exhaust 36 may vary although it is preferable that they are located in adjacent walls. In FIG. 1A, the air intake 46 is readily visible on one of the side walls. Air is drawn in through the air intake 46 by the fan 34 and blown air exits through another side wall through the exhaust 36. In FIG. 1B, the locations of the air intake 46 and the exhaust 36 are reversed. The lid 32 may also be hinged along any lateral wall and should not have a range of motion or location that would interfere with the operative state of the air intake 46 or exhaust 36. Any such interference could cause improper air flow or cause the unit to overheat.

FIG. 2 is a top view of a portable container 10 with the lid 32 removed exposing the cavity 30. The first pair of walls 26 and second pair of walls 28 are shown having a thickness. The location of the fan 34 is more precisely shown as being present within the second pair of walls 28. The exhaust 36 is shown located adjacently in the first pair of walls 26. Again, the location of the fan 34 and exhaust 36 may change but one should generally be adjacent to the other. The walls 26, 28 have a generally solid structure, however, there is a gap within the walls 26, 28 between the fan 34 and exhaust 36 enabling the blown air to be drawn in by the fan 34 and expelled by the exhaust 36.

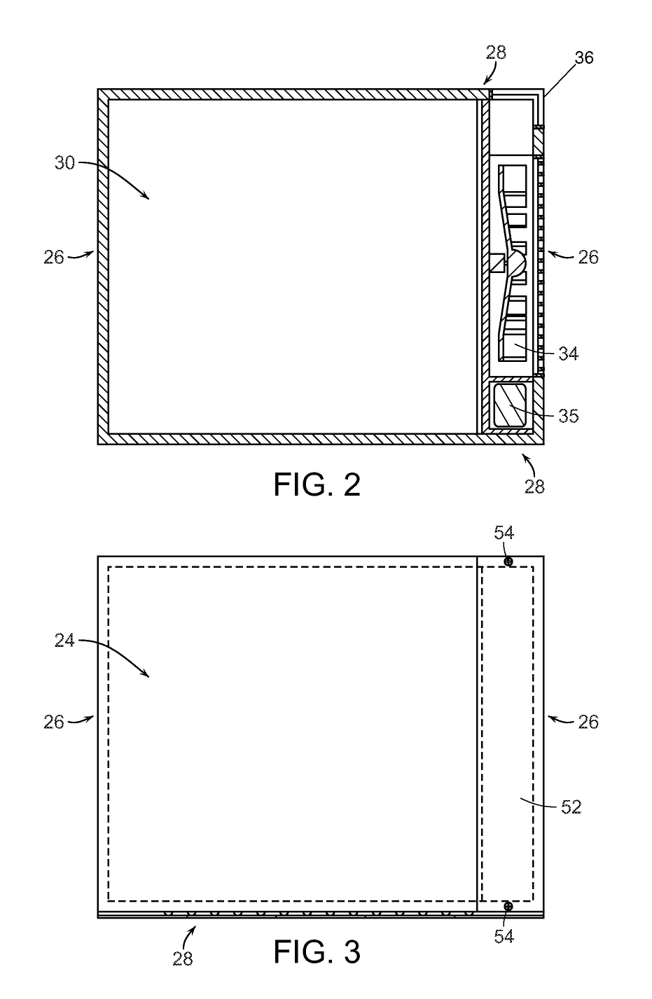

FIG. 3 is a bottom view of a portable container 10. The bottom 24 has a removable cover 52 held in place by at least one screw 54. The removable cover 52 provides access to the fan 34, batteries 35 (shown in FIG. 2) and other components. Additionally, the inclusion of solar cells may provide an alternate power source. Thus, the fan 34 can be accessed to replace parts, change batteries, or otherwise service the unit. The removable cover 52 may also employ pins, tabs, springs, latches, or any combination thereof to hold the removable cover 52 in place.

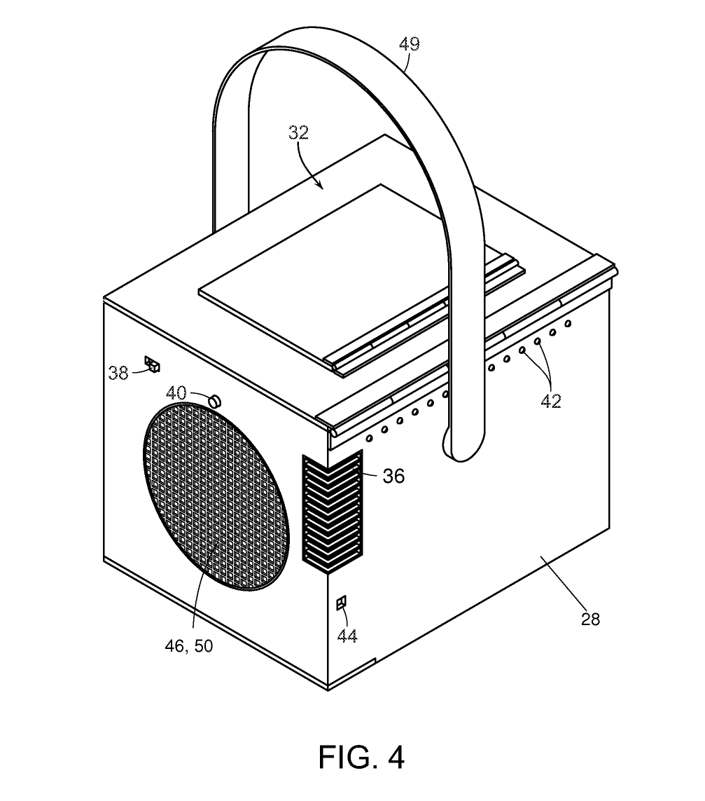

FIG. 4 is a perspective view of the portable container 10 showing the integrated components of the invention. The portable container 10 has an air intake 46 along one of the pair of second walls 28. The air intake 46 is covered with a mesh 50 designed to prevent contact with any of the moving parts behind the mesh 50. The mesh 50 should be appropriately sized to prevent items or body parts (belonging to an infant) to come into contact with these parts. Thus, the openings in the mesh 50 should be less than 5 mm in diameter and more preferably about 1-3 mm in diameter.

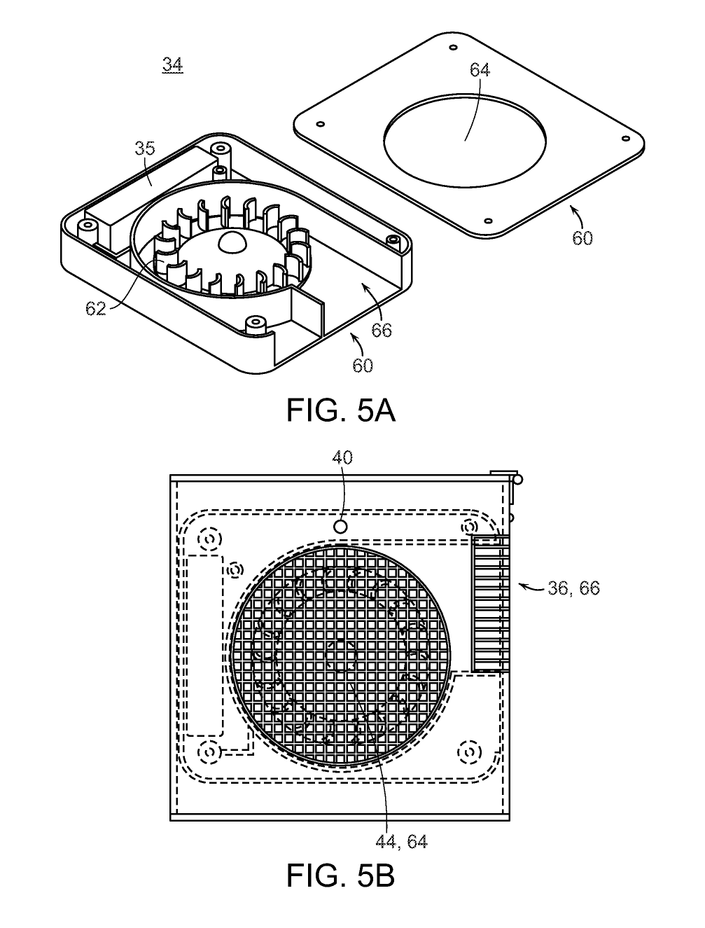

Behind the mesh 50, are the fan 34 (not shown), batteries 35 (not shown) and other internal components. The air intake 46 is connected to the exhaust 36. Preferably the fan 34 is a centrifugal fan (see FIG. 5A) that blows air out of the exhaust 36. The fan is controlled by at least one switch 40. The switch 40 may be used to change the operative state of the fan 34 as well as the speed of the fan 34.

Additionally, the portable container 10 has a plurality of light emitting diodes 42 (LEDs) along at least one lateral edge. The LEDs 42 operative state is controlled by a depressible switch 38. The LEDs 42 may turn on, off, or have variable lighting patterns.

An inlet port 44 exists for supplying fragrance and/or powders to the blown air. The portable container 10 may also have a strap 49 designed for easy carrying of the container 10. The strap 49 preferably is a textile strap that is adjustable in length.

FIG. 5A is an example of the fan 34 used in the present invention. The fan 34 has a housing 60 with an inlet 64 and an outlet 66. The spinning of the impellers 62 draws air in through the inlet 64 and accelerates it pushing it out through the outlet 66. The impellers may be forward curved, backwards curved, or radial. In FIG. 5B, the position of the fan 34 is shown within the wall of the portable container 10.

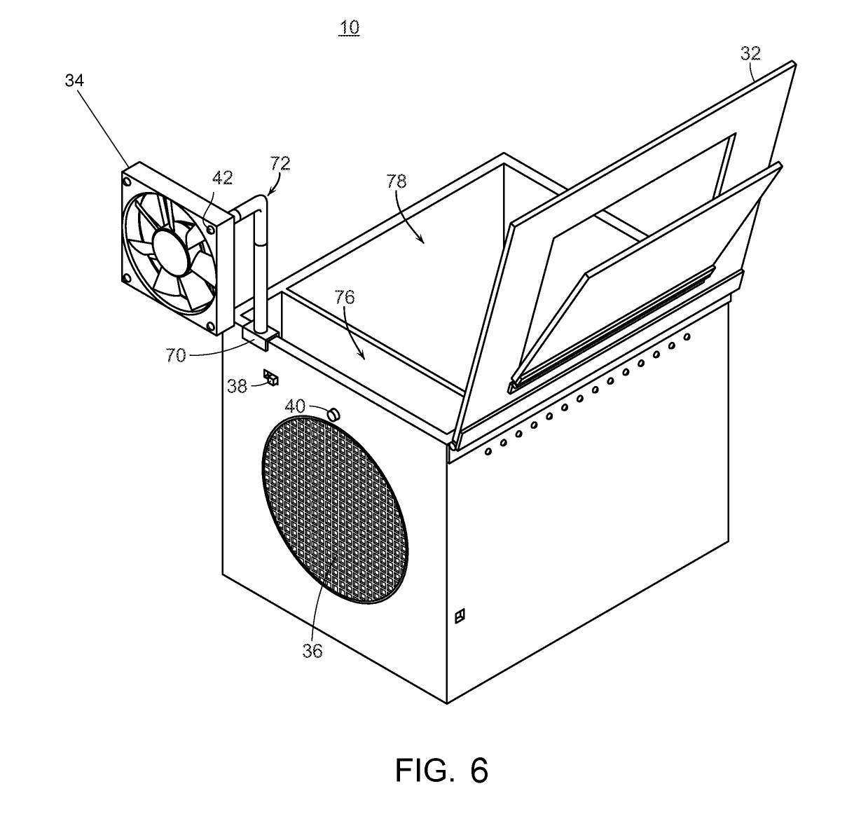

FIG. 6 is an alternate embodiment of the portable container 10 wherein the fan 34 is removable and articulating. The cavity 30 is divided into a storage area 78 and a component area 76. The storage area 78 is used for housing the pre-moistened baby wipes and/or other diaper changing materials. The component area 76 is used for housing the fan 34 and its associated components.

The fan 34 can be used to blow air from either the component area 76 or from a secondary position. When in the component area 76, the blown air is blown through an exhaust 36 located in the side walls. The exhaust 36 may comprise a number of apertures and/or have a number of adjustable slits 48 (as shown in FIG. 1B). The adjustable slits 48 are used to adjust the flow of air without have to reposition the portable container 10. The adjustable slits 48 can be used to direct air flow up/down or side-to-side. Additionally, the adjustable slits 48 may be rotatable. In this configuration the fan 34 can be used within the confines of the portable container, but also can be removed and secured to the portable container 10 using a spring clip 70 or similarly situated securement device.

The fan 34 may also have a hingeable, articulating, telescoping arm 72 that allows the fan 34 to be pointed and direct the air flow in all directions. Additionally, the fan 34 in this configuration has LEDs 42 embedded on the frame to provide an increased visibility when using the fan 34 in a different orientation than of the LEDs 42 on the portable container 10. In some instances, it may be preferable to have more than one or more than one type of fan 34 in the same portable container 10. The fan 34 may further have screening/filtering devices that would prevent the fan 34 becoming laden with particulates and decreasing the air flow or potentially overheating the system.

The portable container 10 should generally be constructed of a lightweight durable material(s) that is economic to produce. Materials may comprise plastic, resins, composites, and potentially some lightweight metals. Plastics may include but are not limited to polyethylene terephthalate (PET), polyethylene (PE), high-density polyethylene, polyvinyl chloride (PVC), polyvinylidene chloride (PVDC), low-density polyethylene (LDPE), polypropylene (PP) , polystyrene (PS), high impact polystyrene (HIPS) and polycarbonate (PC), or any combination thereof. Composites may include but are not limited to fiber reinforced plastics, metal composites, carbon fiber, and Kevlar® and the like. Metals may comprise lightweight metals such as aluminum and other pure metals as well as various alloys. Additionally, the portable container may comprise a combination of classes of materials such as a plastic interior with a textile shell such as woven or unwoven fabric, cloth, terrycloth, woven or non woven fibers of wool, flax, cotton, and synthetic textiles including but not limited to nylon, polyester, and/or acrylic, or any combinations thereof. Various components of the portable container 10 may be comprised of varying material combinations as well.

The portable container 10 should be appropriately sized to house the components of the container 10 while leaving adequate space for the necessary changing supplies, primarily the pre-moistened wipes. Thus, the portable container 10 should be about 13 cm (5 inch) to about 46 cm (18 inch) in length, preferably about 30 cm (12 inch). The portable container 10 should be about 13 cm (5 inch) to about 46 cm (18 inch) in width, preferably about 20 cm (8 inch). The portable container 10 should be about 13 cm (5 inch) to about 46 cm (18 inch) in height, and preferably about 25 cm (10 inch) in height. These dimensions are approximate and may vary depending on the size of the pre-moistened wipes or amount of supplies needed. The dimensions are preferably rectangular; however, varying dimensions may be used creating various shapes and sizes.

The interior compartment, cavity 30, may be further compartmentalized to separate different items within the portable container 10. For example, it may be preferable to have a barrier between a stack of pre-moistened wipes and a container of baby powder. Further, the lid 32 may have a rubberized seal (not shown) or similar means to produce an air resistant seal. The lid 32 and top 22 may also have complimentary shapes that interlock thereby keeping the lid 32 shut until needed. Further, various tabs, latches, springs, keys, etc. may be used to help keep the lid 32 securely fastened. The lid 32 may also be removable instead of being hinged to the housing 20.

What is claimed is:

1. A portable container comprising:
a housing having a top, a bottom, a pair of first walls, and a pair of second walls,
wherein the top has an opening defining a cavity and one of the second walls has a plurality of openings;
a hinged lid attached to the top,
wherein the lid can pivot from an open to a closed position thereby uncovering and covering the cavity;
a dividing wall that compartmentalizes the cavity into a storage area and a component area;
a fan situated in the component area and positioned to blow air outwards from the component area through the plurality of openings in the second wall;
a plurality of light emitting diodes positioned along an outside edge of the container; and
a power source.

2. The portable container of claim 1 wherein the fan is removable and has a telescoping, hingeable arm with a spring clip or a spring clip attached directly to the fan housing.

3. The portable container of claim 1 wherein the power source is a battery or a plurality of solar cells.

4. The portable container of claim 1 wherein the plurality of openings are a series of apertures or directionally adjustable slits.

5. The portable container of claim 1 further comprising an inlet port for adding a fragrance to the blown air.

6. The portable container of claim 1 further comprising a strap attached to the housing, wherein the strap is adjustable.

7. The portable container of claim 1 further comprising at least two depressible buttons for changing the operative state of the fan and changing the operative state of the light emitting diodes.

8. The portable container of claim 4 wherein the slits are vertically, horizontally, and rotatably adjustable.

9. The portable container of claim 1 wherein the storage area is substantially impermeable to air.

10. The portable container of claim 2 wherein the fan can be removed from the component area, attached to various points on the container via the spring clip, and directionally adjusted for increased air flow access.

11. A portable container comprising:
a housing having an outside surface and an inside surface with a top, a bottom, a pair of first walls, and a pair of second walls,
wherein the top has an opening forming a cavity and at least one of the second walls has a plurality of openings on the outside surface of the wall forming an air intake;
a hinged lid attached to the top,
wherein the lid can pivot from an open to a closed position thereby uncovering and covering the cavity;
a fan situated between the inside and outside surface of one of the second walls;
a plurality of light emitting diodes,
wherein the operative state of the light emitting diodes is controlled by a depressible button; and
a power source.

12. The portable container of claim 11 further comprising a strap attached to the housing, wherein the strap is adjustable.

13. The portable container of claim 11 wherein the fan is a centrifugal fan comprising,
a housing having an inlet duct and an outlet duct, and
a series of rotating impellers,
wherein the rotating impellers are either forward curved, backwards curved, or radial blades.

14. The portable container of claim 11 further comprising a section of mesh located between the fan and the outside surface of the second wall.

15. The portable container of claim 12 wherein the openings in the mesh are about 1.5 mm to about 2.0 mm.

16. The portable container of claim 11 further comprising a power switch for changing the operative state of the fan.

17. The portable container of claim 11 further comprising an inlet port,
wherein the inlet port is connected to the air intake thereby allowing fragrance to be added to the blown gases.

18. The portable container of claim 11 further comprising an exhaust port,
wherein the exhaust port expels blown gases generated by the fan.

19. The portable container of claim 13 wherein gases are drawn in through the air intake and expelled through the exhaust port.

20. The portable container of claim 11 further comprising a removable, slidable cover,
wherein removing the slidable cover provides access to the fan and battery compartment.
